(19) United States
(12) Patent Application Publication
(10) Pub. No.: US 2013/0086476 A1
(43) Pub. Date: Apr. 4, 2013

(54) Video Editing Methods and Apparatus

(71) Applicant: David John THOMAS, Henley on Thames (GB)

(72) Inventor: David John THOMAS, Henley on Thames (GB)

(21) Appl. No.: 13/644,420

(22) Filed: Oct. 4, 2012

Related U.S. Application Data
(60) Provisional application No. 61/546,045, filed on Oct. 11, 2011.

(30) Foreign Application Priority Data
Oct. 4, 2011 (GB) 1117011.5

(51) Int. Cl. G06F 3/01

(52) U.S. Cl. 715/723

(57) ABSTRACT

A method and system are disclosed where a user network processor gathers video, audio, metadata and tags from a network server site and from contributing network sites, the material having been provided thereto by contribution devices from one or more sources. The user network processor stores contributed material and then manipulates and edits video strings and audio strings provided in the contributed material using a process that reads metadata and tags to automatically collate material from each source and then uses an editing display screen where collated material from each source is displayed in horizontal timelines along a time axis and a cursor co-operates with timeline selection buttons to select one item at a time to be included into an edited version. The selections are displayed by a selection line joining nodes on the display screen. An edit decision list is generated by the editing process and can be stored and retrieved to operate once again upon the unchanged collected and stored contribution material from the sources which material is left intact by editing. Audio and video material can be separately edited and a further commentary added. A data carrier is also claimed.

### CROSS REFERENCE TO RELATED APPLICATIONS

This application claims the benefit of 35 U.S.C. §119 U.S. Provisional Application No. 61/546,045, filed Oct. 11, 2011, the disclosure of which is incorporated by reference herein in its entirety.

This application claims priority under 35 U.S.C. §119 to GB patent application no. GB 1117011.5, filed Oct. 4, 2011, the disclosure of which is incorporated herein by reference in its entirety.

### TECHNICAL FIELD

The present invention relates to video editing. More particularly, the invention relates to editing digital video clips that can be accompanied by respective audio clips.

### BACKGROUND

It is known to edit multimedia digital video clips. Such digital editing includes a method for creating an edited version of multimedia material from video clips from a plurality of sources.

The present invention seeks to provide improvement there over by improving upon the automatic aspects and/or ease of video clip editing.

### SUMMARY

According to a first aspect, there is provided a method for creating an edited version of multimedia material by string manipulation from a plurality of video sources, the multimedia material containing metadata indicative of the time of acquisition of items of the multimedia material, the method comprising: collating the multimedia material from each source; aligning the collated material from each source on a time axis; and selecting one item at a time along the time axis as part of an edited version.

According to a second aspect, there is provided a computer readable storage medium carrying instructions which, when executed by one or more processors, cause execution of the method of the first aspect

According to a third aspect, there is provided an apparatus for creating an edited version of multimedia material, by string manipulation, the apparatus comprising a memory storing instructions which, when processed by one or more processors cause: collating, from each one of a plurality of video sources, multimedia material containing metadata indicative of the time of acquisition of items of the multimedia material from the source; determining the time of acquisition of each item of multimedia material; collating the multimedia material from each source; aligning the collated material from each source on a time axis; and selecting one item at a time along the time axis as part of an edited version.

According to yet another aspect, there is provided apparatus for creating an edited version of multimedia material from a plurality of sources, by string manipulation, the multimedia material containing metadata indicative of the time of acquisition of items of the multimedia material, said apparatus comprising: a processor; a data bus coupled to said processor; and a computer usable medium embodying computer program code, said computer usable medium being coupled to said data bus; and said computer program code comprising instructions executable by said processor and configured to: determine the time of acquisition of each item of multimedia material; collate the multimedia material from each source; align the collated material from each source on a time axis; and select one item at a time along the time axis as part of an edited version.

According to yet another aspect, there is provided a computer readable storage medium for creating an edited version of multimedia material, by string manipulation, the computer readable storage medium carrying instructions which, when processed by one or more processors cause: collating, from each one of a plurality of video sources, multimedia material containing metadata indicative of the time of acquisition of items of the multimedia material from the source; determining the time of acquisition of each item of multimedia material; aligning the collated material from each source on a time axis; and selecting one item at a time along the time axis as part of an edited version.

One or some embodiments also provide that an edit decision list can be created reflecting the selections made to provide the edited version; and that the edit decision list can be stored to enable later re-creation of the edited version from the stored multimedia material.

One or some embodiments also provide that the multimedia material can be collected and stored from a plurality of sources; and that the metadata in each item of multimedia material can be examined to determine the time of acquisition of each item of multimedia material.

One or some embodiments further provide that collecting multimedia material can involve access to network connected sources.

One or some embodiments also provide that the multimedia material is collectable by access to network connected sources, where the network can be, but is not restricted to: a local area network (LAN); a wide area network (WAN): a home network; and a wireless network.

One or some embodiments also provide that the multimedia material can include at least one of: video material; audio material; static images; and metadata indicative of at least one of: time of acquisition of items of the multimedia material; identification of a contributor; comments of a contributor; and position of a contributor when an item was acquired.

One or some embodiments also provide that the selecting one item at a time along the time axis can include employing an interface including a screen image, whereon: collated contribution items from each of the plurality of sources can be displayed along a plurality of respective parallel, adjacent, vertically spaced timelines in a horizontal direction in the direction of the time axis; and a moveable cursor can be displayed crossing the timelines in a vertical direction; where the cursor can be moveable to coincide with an item on a desired source timeline; and the desired source timeline can be activated to select the item for inclusion in the edited version.

One or some embodiments also provide that the time axis can be annotated with flagged events significant for editing.

One or some embodiments also provide that visual representation can be provided of a selection line indicative of a path between nodes positioned on selected items and those nodes can be adjusted to alter the edited version.

One or some embodiments also provide that separate visual representation for video and audio items can be provided, and that separate selection for video and audio items can also be provided.

One or some embodiments also provide for adjusting nodes to alter the edited version.

One or some embodiments also provide for provision of separate visual representation for video and audio items, and providing separate selection for video and audio items.

One or some embodiments also provide for either: provision of separate selection screens for video material and for audio material; or provision of the same selection screen for video and audio material.

One or some embodiments also permits providing an editing user provided audio commentary among the multimedia material.

### BRIEF DESCRIPTION OF THE DRAWINGS

Embodiments are further explained, by way of example, by the following description to be read in conjunction with the appended drawings, in which:

FIG. 1 is an exemplary schematic diagram of one of many different environments wherein the present inventions may be practised.

FIG. 2 shows an exemplary block diagram of a typical system capable of putting the invention into practise.

FIG. 3 is an exemplary block diagram illustrating the program content of the CPU.

FIG. 4 is an exemplary flow chart illustration one way in which the data collector software package 42 can cause the user processor apparatus to collect video clips from the video contribution devices.

FIG. 5 is an exemplary flow chart illustrating one way in which the position determination software package can cause the user processor apparatus to order the collected data for editing.

FIG. 6 is an exemplary screen shot of one of many Graphic User Interfaces that can be presented by the user processor apparatus to provide information to and to allow manipulation by a user to allow user choice in the video editing process under the control of the video footage editing software package.

FIG. 7 is an exemplary flow chart showing one way in which the user processor apparatus can execute the final processes in the overall editing operation including the audio commentator software package shown in FIG. 3.

FIG. 8 is an exemplary screen shot of one of many Graphic User Interfaces that can be presented by the user processor apparatus when executing the string manipulation module software package of FIG. 2 to provide information to and to allow manipulation by a user of the user processor apparatus thereby allowing user choice in the audio editing process under the control of the audio commentator software package shown in FIG. 2.

FIG. 9 is a flow chart showing the string manipulation executed by the string manipulation module of FIG. 2 when the video footage editing software package and the audio commentator software package 48 are executed by the user processor apparatus.

### DETAILED DESCRIPTION

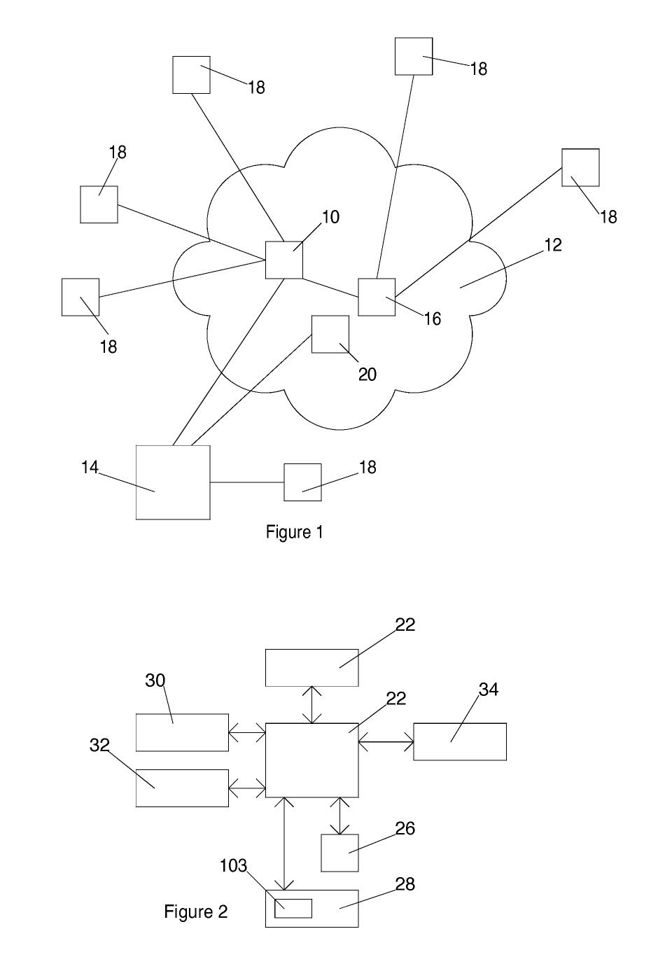

Attention is drawn to FIG. 1, an exemplary schematic diagram of one of many different environments wherein embodiments of the present inventions may be practised.

A network server site 10 is provided within a network 12 which, for preference, is the Internet, but equally can be any one of, combination of, or interconnection of, but not restricted to: a local area network (LAN); a wide area network (WAN): a home network; and a wireless network.

A user processor apparatus 14 communicates with the network server site 10 and also with one or more clip contributing sites 16 to acquire video clips contributed from any one or more of a plurality of video contributing devices 18 each of which can be coupled to communicate with the network server site 10 or a clip contributing site 16, or both, to contribute a clip to the network server site 10 and thence for the network server site 10 to deliver the clip to the user processor apparatus 14. Clips can be also be delivered by one or more video contributing devices 18 either directly (as shown) to the user processor apparatus 14 or via a non -network chain of delivery by a succession of storage devices (not shown).

The video contributing devices 18 can be, but are not limited to: video camera devices; mobile telephone devices; smart phone devices; portable processor devices; Personal Computer (PC) devices; surveillance devices; and orbital satellite camera devices.

The contributed clips can comprise one, some or all of: a static image; a moving picture video image; one or more clip sound tracks; tags; and metadata.

The metadata can be of any form, and can be variously provided as, but not limited to, one, all or some of: as data embedded within a static image; as data embedded within a video image; as download information provided when the clip contrition was made by a video contribution device 18; and as network 12 connection information. The metadata can comprise, but is not limited to, one, all or some of: time of image acquisition; place of image acquisition; identity of an image contributor or contributors; sound track time of origin; sound track place of origin; identity of provider of sound track; identity of any speakers; and any other associated information.

The contributor delivered clips can be previously un-edited, or can be the result of editing processes by others, including contributors.

Within embodiments, clips can be delivered to the user processor apparatus 14 by any means, including, but not limited to, at least one of: network delivery; email delivery; manual delivery using portable memory device delivery such as, but not limited to, memory stick and outboard memory store; and direct data download delivery.

The user processor apparatus 14 performs an editing process upon selected received clips, and provides edited output to one or more user apparatus output receiving sites 20 where edited material is made available to others. As an alternative, the edited material can be stored, with or without provision to the one or more output receiving sites 20, by the user processor apparatus 14.

In FIG. 1, the user processor 14 is shown as an entity external to the network 12. It is to be appreciated that the user processor can be provided within the network sever site 14 and the editing process performed under user control from one or more sets of user apparatus external to the network 12 and connectible for control communication to the network server site 10. It is also to be appreciated that any one of the individual network sites 10 16 20 can be a so called “Cloud” where the function of an individual site 10 16 20 is disseminated among one or more actual network server sites but none the less accessed using a single network address.

Indeed, one or more embodiments only requires that one or more clips can be delivered to an editing process that provides edited output from one or more selected clips.

Attention is next drawn to FIG. 2. Typically, embodiments will be carried out using a software system such as, but not limited to, a user processor apparatus 14 having the system shown in FIG. 2.

A network interface 22 is coupled to a central processor unit (CPU) 24 operable to execute a program under control of program software provided in a random access memory (RAM) 26 and also in a storage memory 28 such as a disc drive. The storage memory 28 and the RAM 26 are also available to the CPU 24 for temporary or permanent storage of results and data.

The CPU 24 is coupled to receive input from one or more input devices such as, but not limited to, a pointing device 30 such as a mouse, pad or touch screen; and a text input device 32 such as a keyboard or touch screen.

The CPU 24 also drives a display 34 that displays images and provides sounds as controlled and provided by the CPU 24.

The system, as described in relation to FIG. 2, can also be split and disseminated in several parts or network clouds. All that is required, in the embodiments, is that a system can be provided capable or providing the editing functionality as described hereafter.

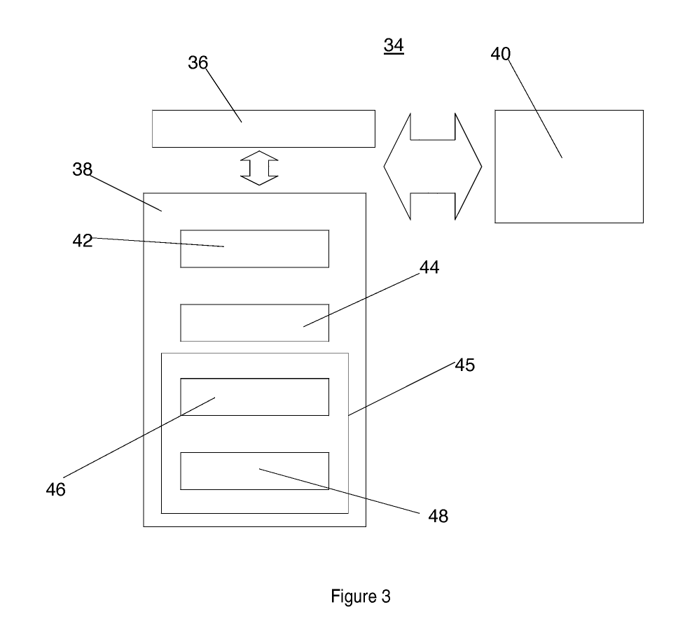

Attention is next drawn to FIG. 3, an exemplary block diagram illustrating the program content of the CPR 24.

The CPU 24 is organized and driven by an operating system 36 that, together with the rest of the computer, runs a video editing software package 38 which the operating system 36 also runs interface software 40 that permits access, when required, to allow interaction with internet sites 10 16 20 22 and integral devices such as the pointing device 20, the text input device 32, and with any data input and output sockets.

The video editing software package 38 comprises data collector software package 42 that allows the user processor apparatus 14 to collect video clips from the video contribution devices 18 as described heretofore, together with metadata and audio tracks.

The video editing software package also 38 comprises a position determination software package 44 that causes the user processor apparatus 14 to read the metadata input from each selected contribution device 18, and determine the order of acquisition by the particular contribution device 18 of the still image, video clip and any audio track material. Not all types of material need to be present, and not all types of material need to be acquired at the same time.

The video editing software package 38 further comprises a string manipulator module software package 45 in turn comprising a video footage editing software package 46 and an audio commentary editing software package 48.

The video footage editor software package 46 is operable to cause the user processor apparatus 14 to execute a video clip editing program as hereafter described.

The audio commentary editing software package 48 is operable to cause the user processor apparatus 14 to execute addition of an audio commentary and selection of associated audio tracks to appear in the final production of the edited collection of clips created by use of one or more embodiments, as later described.

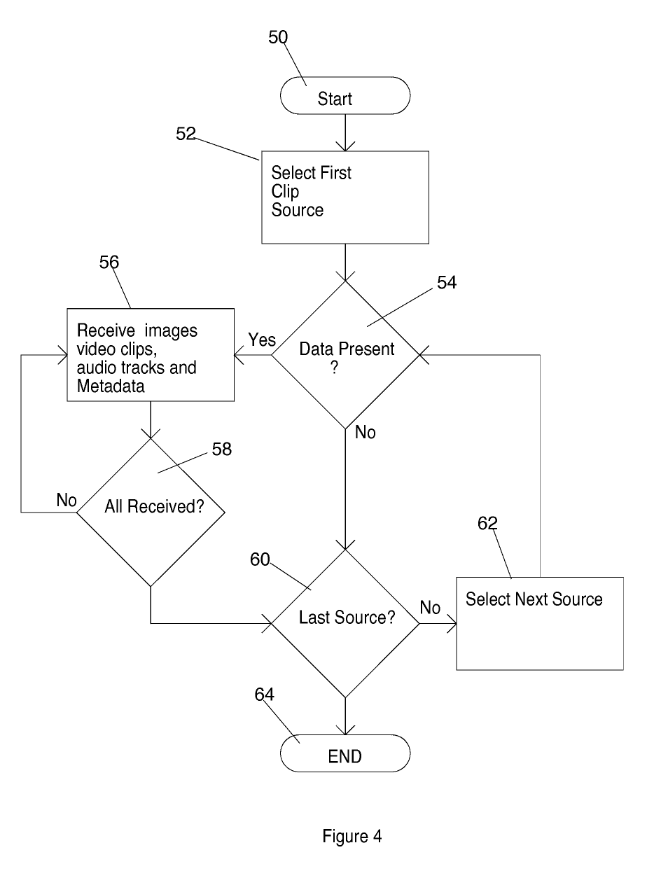

Attention is next drawn to FIG. 4, an exemplary flow chart illustration one way in which the data collector software package 42 can cause the user processor apparatus 14 to collect video clips from video sources comprising video contribution devices 18 and/or sites 16.

From Start 50 a first operation 52 selects the first clip source that can be any selected one of one or more clip contributing sites 16 and one or more video contribution apparatus 18, as shown in FIG. 1 and as described in relation thereto.

A first test 54 than checks to see if any downloadable data in the form of images, video clips, audio tracks and metadata is present at the first source.

If downloadable data is present, a second operation 56 downloads all of the data available from the selected source until a second test 58 finds that all of the data from that source has been downloaded and passes control to a third test 60 to see if the selected source is the final source.

If the first test 54 finds that there is no data available from the selected source, the first test 54 passes control directly to the third test 60.

If the third test 60 finds that the selected source is not the final source, a third operation 62 selects the next source and passes control to the first test 54.

If the third test 60 finds that the selected source is the final source, control is passed to End 64 that stores the collected data and ends the data collection activity of the user processor apparatus 14.

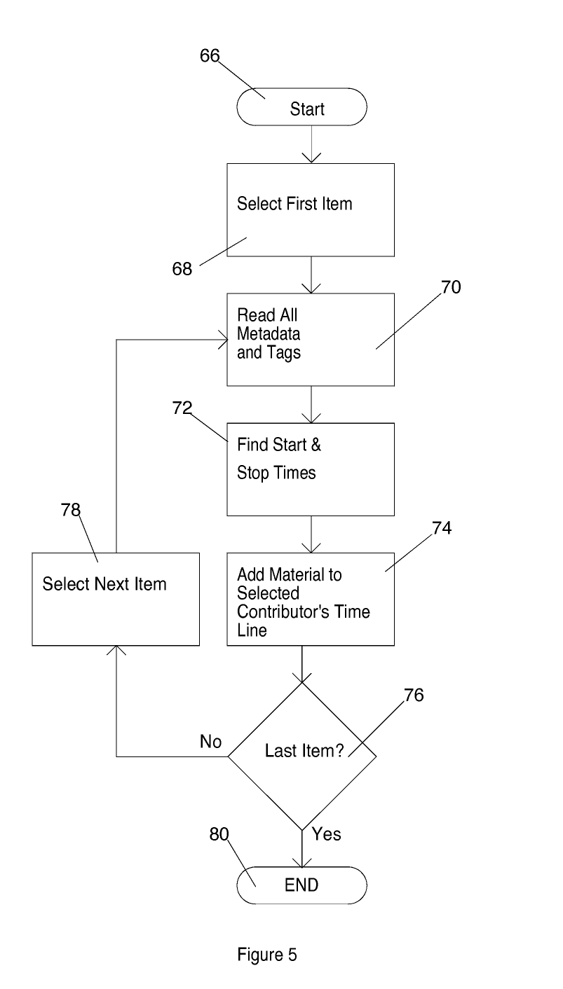

Attention is next drawn to FIG. 5, an exemplary flow chart illustrating one way in which the position determination software package 44 can cause the user processor apparatus 14 to order the collected data for editing.

From a start 66 a fourth operation 68 causes the user processor apparatus 14 to select the first contributed item that has been obtained from a video contribution device 18 and stored in the user processor apparatus 14.

A fifth operation 70 then has the user processor apparatus 14 read all of the metadata and any tags that accompany the contribution. Such metadata and tags included time of acquisition, date of acquisition, contributor details, and, most importantly for the present processes, the start and stop times for every video portion. Each video portion can also be accompanied by a respective audio track.

A sixth operation 72 then has the user processor apparatus 14 find the start and stop times for video portions in the selected contribution and a seventh operation 74 adds the video material into a time line for that contributor where video-present epochs are provided with the video material and video-absent epochs are left blank, in a manner that will become clear hereafter.

A fourth test 76 then checks to see if the selected downloaded item is the last item. If not, an eighth operation 78 selects the next item to review and passes control back to the fifth operation 70 to begin the analysis again for the next item.

If the fourth test 76 finds that the selected item is the last item, control passes to END 80 that terminates the position determination process.

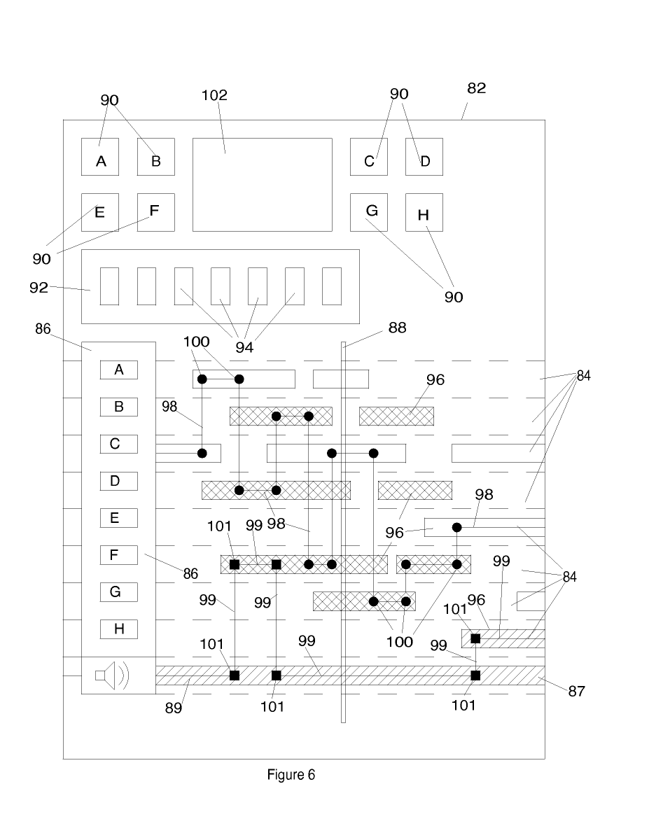

Attention is next drawn to FIG. 6, an exemplary screen shot of one of many Graphic User Interfaces that can be presented by the user processor apparatus 14 when executing the string manipulation module software package 45 to provide information to and to allow manipulation by a user of the user processor apparatus 14 to allow user choice in the video editing process under the control of the video footage editing software package 46.

A screen image 82 presents the content of each contribution timeline by presentation of each contribution on a respective one of a plurality of individual screen timelines 84 respectively designated my markers on a timeline identity bar 86 running vertically across the screen timelines 86. The screen timelines 86 are disposed side by side, in abutment with one anther, running horizontally across screen image 82 with earlier times positioned to the left of later times on a time axis where horizontal distance is proportional to separation in time. A vertical cursor 88 is positioned along the horizontal axis to select positions along the screen timelines 86. One of a plurality of timeline selection buttons 90 is depressed to select a particular timeline 86 at the point that it is co-incident with the cursor 88. A command type selector bar 92 has a plurality of command selector buttons 94 displayed thereon. The command selector buttons 94 can each be depressed to select the command that the video footage editing software package 46 obeys.

On each screen timeline 86 the times for which multimedia content is present is indicated by one or more sequential multimedia presence indicators 96 in the form of one or more horizontal bars.

Also present is a commentary timeline 87 containing a commentary 89 contributed by the editing user and provided at a user selected point along the time axis, indicated in the timeline identity bar 86 of FIG. 6 by a loudspeaker symbol. The commentary timeline multimedia material is strictly audio material that can be re-recorded, in whole or in part, at any time, for a re-editing session if it is desired to make further changes. In FIG. 6 the audio commentary 89 is show as a continuous presence in the commentary timeline 87, even though, it is to be understood, it can contain sections which are devoid of sound. The commentary 89 can contain any audio contribution, such as recoded sounds and music, speech by the user and speech by others.

Some multimedia material can comprise both audio and visual material, indicated in FIG. 6 by doubly crosshatched multimedia indicators 96, examples being found in screen timelines 84 B, D F and G. Some multimedia material can comprise video material alone, indicated in FIG. 6 by clear multimedia indicators 96, examples being found in screen timelines 84 A, C and E. Some multimedia material can comprise purely audio material, shown in FIG. 6 by singly crosshatched multimedia indicators 96 89, as illustrated in this example by screen timeline 86 H and the commentary screen timeline 87. Still other screen timelines 86 can comprise a spaced plurality of different types of multimedia material as illustrated in this example by screen time line 86 G.

The user of the user processor apparatus 14 uses the controls to create a video selection line 98 that is positioned between video nodes 100 indicating the position of a selected video string. In FIG. 6 video nodes are represented as being circular. The position of each video node 100 is selected by use of the cursor 88 and of the appropriate timeline selector button 94. The video selection line 98 determines which portions of which contributions are included in the final edited version.

An audio selection line 99 indicating the position of elements within a selected audio string, is drawn between audio nodes 101 represented in FIG. 6 as being square elements. During video editing to manipulate the video string as indicated, the selected audio string indicated by the audio selection lime 101 is provided and shown, and during audio editing to manipulated the audio string (later described) the selected video string indicated by the video selection line 100 is provided and shown.

The screen image 82 covers only a portion of the overall timeline, and the user of the user processor apparatus 14 can move the screen image earlier and later to edit the entire timeline.

Operations possible to the user of the user processor apparatus can include, but are not limited to: add a node; move a node; drag a node; change node selected contributor; and remove a node.

If a contributor contributes a static image, it can be caused to occupy an entire timeline, thereby allowing switching to the static between selected video displays. Use of one or more static images can be used to provide emphasis and illustration to commentaries.

If no recorded material is present in any of the contributions for a portion of their timelines, an option is to allow automatic truncation of portions of the timeline where media is absent.

Another option is to permit annotation of the timeline with operator or user flagged events that would be considered significant for editing purposes.

Another option is to permit annotation of significant events, embedded as metadata by the contributor, being used as indication of significance for editing purposes.

Another variation permits the timeline of a contribution to be slipped forwards or backwards relative to general timeline to permit inclusion of timeline slipped material in areas where a gap might be left due to no other suitable contributed material being present.

Another variation allows the ability to loop back through the timeline repeatedly, so that instead of mandatory vertical and horizontal paths for the video selection line 98, video selection lines 98 moving forward and backwards in time are permitted.

The editing process manipulating timelines 87 84 also creates an edit decision list file 103 (shown in FIG. 2 within storage memory 28) containing the choices made for the video path and audio path in creation of video and audio strings. At the end of the editorial selection, edit decision list is stored so as to be able, as required, to re-create the final edited video and audio version from the stored original intact contributions.

For clarity, in this example the video selection line in FIG. 6 selects the sequence of video elements to be shown i9n the re-creation of the video string as:

CADBFCGFE

To view editing results “so far” a view button 102 can be depressed for the user processor apparatus to employ some or all of the screen image 82 to show the overall result of video (and audio) selection.

This provides the user of the user processor apparatus 14 with an easily grasped intuitively comprehensible editing facility. The editing process offers improvement over prior art by avoiding alteration of any kind to video or audio material that are therefore present in an intact state for future work and reference.

The various contributions 86 87 may be differently displayed from the way they are shown in FIG. 6, and can be, but are not limited to: side by side display in the same screen timeline 84; audio and video contributions being provided is separate screen timelines 84 87, and display distinguished by different colours.

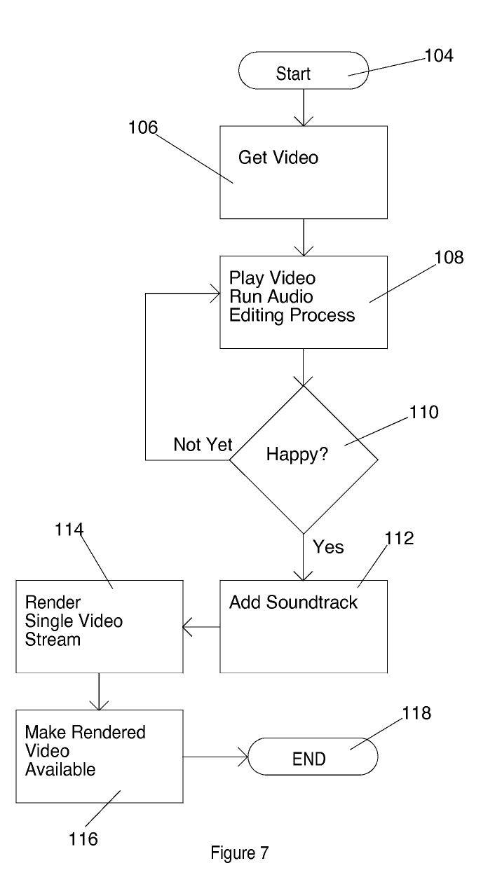

Attention is next drawn to FIG. 7, an exemplary flow chart showing one way in which the user processor apparatus 14 can execute the final processes in the overall editing operation including the audio commentator software package 48 shown in FIG. 3.

From start 104 a ninth operation 106 retrieves from storage the completed edited edition of the contributed video items and a tenth operation 108 then applies an audio editing process where the edited video is played and contributed and user added audio is selected and tested against the played edited video until a fifth test 110 finds that the user is now happy with the end result. The audio editing process can be run using a similarly operable screen image as that shown in FIG. 6 but with audio contributions shown instead video contributions and with a user provided audio track contribution bearing user provided commentary in sympathy with the content of the edited video material.

From the fifth test 110 an eleventh operation 112 adds the edited and accepted soundtrack to the edited and accepted video material to make a complete edited package.

A twelfth operation 114 then renders the complete edited package into a rendered video stream. Native footage is converted into a steam format with the video and audio material combined together and the whole video package format converted, if necessary, to bring all of the contributed elements into the same format as the rendered video stream.

A thirteenth operation 116 then makes the rendered video stream package available, for example, by placing it onto one or more network sites such as, but not limited to; the network server site 10; the clip contributing site 16; a social network site; and a news gathering site. Indeed, the user can elect any one or more website addresses whereto the rendered video stream package is to be delivered.

The thirteenth operation 116 having completed its operation, an END 118 brings the overall editing process to completion.

The overall editing allows contributed material to remain intact, and can be made the subject of later further editing efforts.

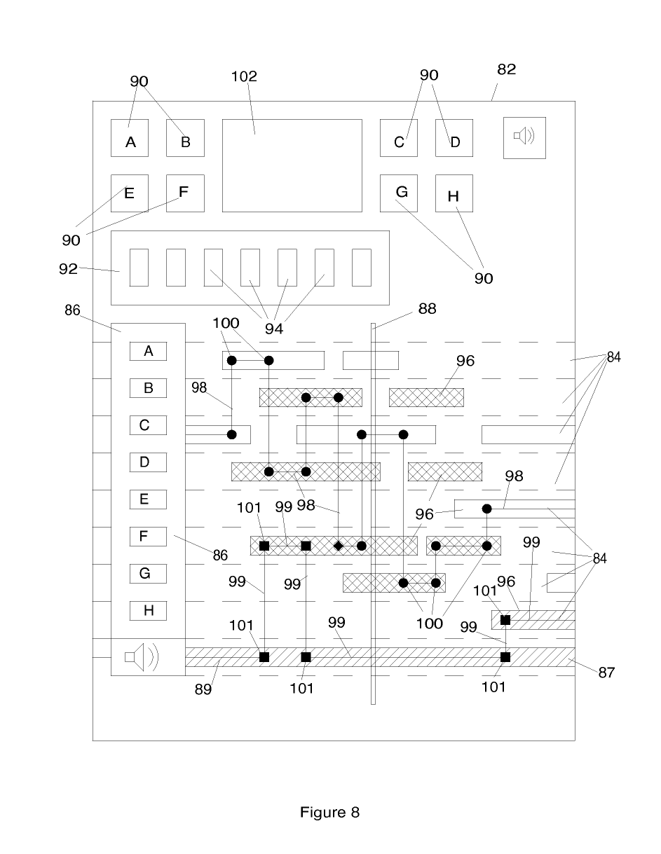

Attention is next drawn to FIG. 8, an exemplary screen shot of one of many Graphic User Interfaces that can be presented by the user processor apparatus 14 when executing the string manipulation module software package 45 to provide information to and to allow manipulation by a user of the user processor apparatus 14 thereby allowing user choice in the audio editing process under the control of the audio commentator software package 48 shown in FIG. 2.

Nearly all elements in FIG. 8 have correspondence and identity with elements in FIG. 6 and like numbers denote like elements. The function of and possible variations in function and nature of each corresponding element are the same as described in relation to FIG. 6 and no further explanation is given for FIG. 8.

FIG. 8 has, in addition over FIG. 6, a commentary 87 selection button 91 which is depressible by the user, when editing audio content by manipulating the audio string, to select the commentary 89 display timeline 87 for positioning, dragging and dropping, deleting, creating or moving of an audio node 101.

Manipulation of the audio string as shown by the audio selection line 99 is achieved in the same way that video string manipulation is achieved as shown in FIG. 6. The selected video string indicated by the video selection line 98 is shown during audio editing and vice versa.

The user can flip between the screen of FIG. 6 and the screen of FIG. 8 until a combination of audio and video material is achieved, to the users satisfaction.

During video string manipulation, no audio node 101 can be manipulated, and a video node 100 cannot be created or moved to an item 89 96 at a position that does not contain vide material. During audio string manipulation, no video node 100 can be manipulated and no audio node 101 can be created, moved or positioned onto an item 89 96 that does not contain audio material.

For clarity of explanation, in this example, the selected audio sources shown in FIG. 8, in timeline order, is

Commentary 89, Timeline F, Commentary 89, Timeline H.

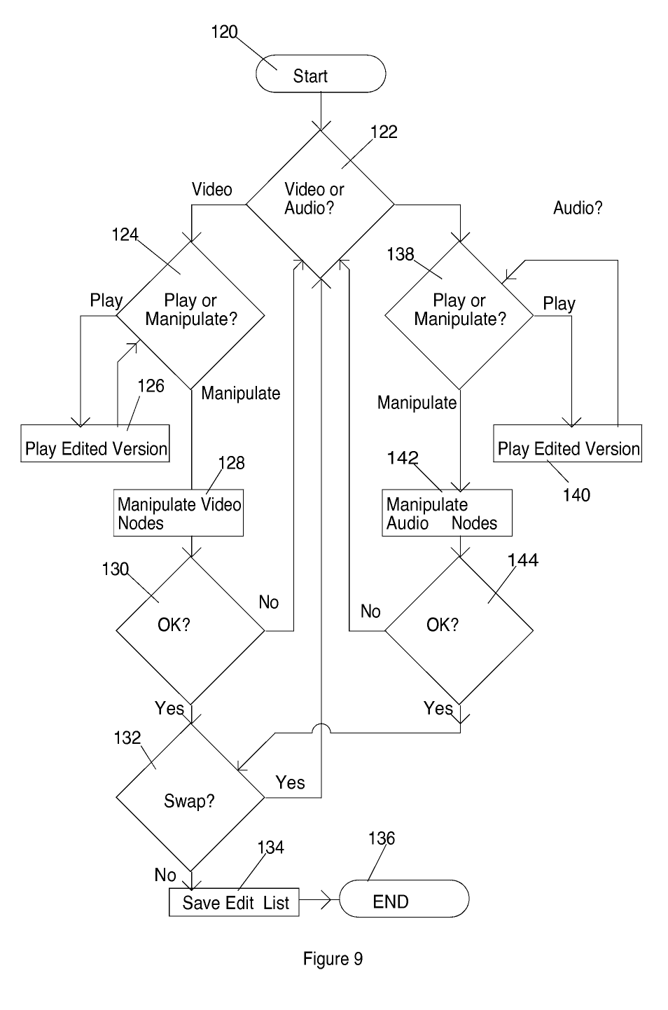

Attention is next drawn to FIG. 9, a flow chart showing the string manipulation executed by the string manipulation module 45 of FIG. 2 when the video footage editing software package 46 and the audio commentator software package 48 are executed by the user processor apparatus 14.

From a start 120 a sixth test 122 checks to see which of video or audio editing and manipulation the user has chosen.

If the user has chosen video editing and string manipulation, a seventh test 124 checks to see is the user wishes to play the edited video version so far created or to go straight into string manipulation.

If the user wishes to play the edited version so far created, a fourteenth operation 126 plays the edited video version so far created selectably with or without the edited audio version so far created. The fourteenth operation 126 returns control back to the seventh test 124.

The current edited version so far is created, and is created in every instance of playing hereafter and here before described, by retrieving the edit list from the edit list decision store 103 and recreating the edited version of the various multimedia contributions.

During actual video or audio string manipulation, as described hereafter, at each manipulation and editing stage, the resulting edit list can be stored as the final edit list, or, for preference, a temporary edit list can be created that is stored in the edit decision list file 103 when the current editing and manipulation session is ending.

If the seventh test 124 finds that the user wishes to go to video string manipulation and editing, the seventh test 124 passes control to a fifteenth operation 128 that provides video string manipulation and editing, as already extensively described, by moving video nodes 100 to different positions along the timeline, moving video nodes 100 to different screen timelines 84, creating new video nodes 100, and deleting video nodes 100. The fifteenth operation 128 allows the user to play the edited and manipulated video string, with or without the accompanying audio string.

When an eighth test 130 finds that the user is happy with the result, control passes to a ninth test 132 checks to see if the user wishes to swap between video and audio string editing and manipulation. If then user desired to swap, control is passed back to the sixth test 122 where the user is able to select between video sting manipulation and audio string manipulation.

If the eighth test 130 find that user is not happy with the result, the eighth test 130 passes control back to the sixth test 122 where the user is able to select between video sting manipulation and audio string manipulation.

If the ninth test 132 finds that the user does not wish to swap, the ninth test 132 passes control to a sixteenth operation 134 that stores the edit list in the edit decision list file 103 and then passes to end 136 that terminates the current string manipulation and editing session.

Going back to the sixth test 122, if the user elects audio string manipulation and editing, a tenth test 138 checks to see is the user wishes to play the edited video and audio version so far created or to go straight into audio string manipulation.

If the user wishes to play the edited version so far created, a seventeenth operation 140 plays the edited video version so far created. The seventeenth operation 140 returns control to the tenth test 138.

If the tenth test 138 finds that the user wishes to manipulated and edit the audio string, an eighteenth operation 142 allows the user to manipulate and edit the audio nodes 101, as already extensively described, by moving audio nodes 101 to different positions along the timeline, moving audio nodes 101 to different screen timelines 84, creating new audio nodes 101, and deleting audio nodes 101. The eighteenth operation 142 allows the user to play the edited and manipulated video and audio string. If an eleventh test 144 finds that the user is content with the resulting manipulated and edited audio string, the eleventh test passes control to the ninth test 132. If the eleventh test finds that the user is not content with the edited and manipulated version of the material so far, control is passed back to the sixth test 122 where the user can elect to perform more video or audio string manipulation and editing.

During video string manipulation and editing, performed by the fifteenth operation 128, and during audio string manipulation and editing, performed by the eighteenth operation 142, the user has the a timeline manipulation option comprising, but not limited to; truncating areas of timeline where no desired items are present; copying items to other locations on the timeline; moving items to other places in a timeline; deleting items from the timelines; deleting timelines; and adding timelines 86. All of these manipulation activities relate only to the edited and manipulated version, and the original gathered material remains stored intact for later use in later versions if desired. Optional timeline manipulation allows material to be presented in an editorially coherent way, and in any order, if so desired.

Addition and deletion of timelines also has the advantage that different audio commentaries 89 can be substituted into the commentary timeline 87 thereby allowing use of different regional versions and other languages.

The flow chart of FIG. 9 is purely exemplary, and the skilled person will be aware of many variations and clear improvements that can be made without departing from the invention as filed.

The invention has been described so far in terms of one of many possible embodiments. The skilled man will also be aware of different orders of execution and manners of execution that are possible without departing from the invention as claimed.

Although some embodiments are shown to include certain features, the applicant(s) specifically contemplate that any feature disclosed herein may be used together or in combination with any other feature on any embodiment of the invention. Many variations of the invention will occur to those skilled in the art. All such variations are intended to be within the scope and spirit of the invention.

1. A method for creating an edited version of multimedia material, by string manipulation, the method comprising:
collating, from each one of a plurality of video sources, multimedia material containing metadata indicative of the time of acquisition of items of the multimedia material from the source;
aligning the collated material from each source on a time axis; and
selecting one item at a time along the time axis as part of an edited version.

2. The method of claim 1 also comprising:
creating an edit decision list reflecting the selections made to provide the edited version; and
storing the edit decision list to enable later re-creation of the edited version from the stored multimedia material.

3. The method of claim 1 also comprising:
collecting and storing multimedia material from a plurality of video sources;
examining the metadata in each item of multimedia material to determine the time of acquisition of each item of multimedia material.

4. The method according to claim 3, where collecting multimedia material involves accessing network connected sources.

5. The method of claim 2 for use where the multimedia material includes at least one of: video material; audio material; static images; and metadata indicative of at least one of: time of acquisition of items of the multimedia material; identification of a contributor; comments of a contributor; and position of a contributor when an item was acquired.

6. The method of claims 1, wherein selecting one item at a time along the time axis comprises;
employing an interface including a screen image, whereon:
collated contribution items from each of the plurality of video sources are displayed along a plurality of respective parallel, adjacent, vertically spaced timelines in a horizontal direction in the direction of the time axis;
a moveable cursor is displayed crossing the timelines in a vertical direction;
the method further comprising:
moving the cursor to coincide with an item on a desired source timeline; and
activating the desired source timeline to select the item for inclusion in the edited version.

7. The method according to claim 6 including annotating the time axis with flagged events significant for editing.

8. The method of claim 7, including providing visual representation of a selection line indicative of a path between nodes positioned on selected items.

9. The method, according claim 8, including adjusting nodes to alter the edited version.

10. The method of claim 6 , comprising providing separate visual representation for video and audio items, and providing separate selection for video and audio items.

11. The method according to any of claim 6 comprising employing respective separate selection screens for video material and for audio material.

12. The method according to claim 6 comprising employing the same selection screen for video and audio material.

13. The method, according to claim 8, including:
displaying a video selection line on an audio selection screen; and
displaying an audio selection line on a video selection screen.

14. The method of claim 1, including:
providing an editing user provided audio commentary among the multimedia material

15. The method, according to claim 1, including truncating portions of the time axis from which items are absent.

16. A computer readable storage medium carrying instructions which, when executed by one or more processors, cause the method of claim 1.

17. The medium of claim 16 where the computer readable storage medium is one of: a recorded disc; a solid state memory device; and a network message.

18. An apparatus for creating an edited version of multimedia material, by string manipulation, the apparatus comprising a memory storing instructions which, when processed by one or more processors cause:
collating, from each one of a plurality of video sources, multimedia material containing metadata indicative of the time of acquisition of items of the multimedia material from the source;
determining the time of acquisition of each item of multimedia material aligning the collated material from each source on a time axis; and
selecting one item at a time along the time axis as part of an edited version.

19. apparatus of claim 18, wherein the memory stores additional instructions which, when processed by the one or more processors, cause creating an edit decision list reflecting the selections made to provide the edited version; and
storing the edit decision list to enable later re-creation of the edited version from the stored multimedia material.

20. The apparatus, according to claim 18, wherein the memory stores additional instructions which, when processed by the one or more processors, cause:
collecting and storing multimedia material from a plurality of sources; and
examining the metadata in each item of multimedia material to determine the time of acquisition of each item of multimedia material.
